(19) United States
(12) Patent Application Publication
(10) Pub. No.: US 2010/0328296 A1
(43) Pub. Date: Dec. 30, 2010

(54) PLASMA DISPLAY DEVICE

(75) Inventor: Kunio TAKAYAMA, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/771,044

(22) Filed: Apr. 30, 2010

(30) Foreign Application Priority Data
Apr. 30, 2009 (KR) 10-2009-0038432

(51) Int. Cl. G09G 3/28; G09G 5/00

(52) U.S. Cl. 345/212; 345/60

(57) ABSTRACT

A plasma display device that inexpensively improves uniformity of luminance in a vertical direction of a PDP. The plasma display device includes: a plasma display panel (PDP) having an X electrode and Y electrode that are disposed parallel to each other while intersecting an address electrode at a discharge cell; a Y-board assembly that controls the Y electrode of the PDP; a Y-buffer-board assembly including a scan integrated circuit (IC) connected to the Y-board assembly to apply a scan voltage waveform and a sustain voltage waveform to the Y electrode; and a current supply element included in the Y-buffer-board assembly to supply a ground voltage to the Y-board assembly and to prevent overshooting of the sustain voltage waveform.

### CROSS-REFERENCE TO RELATED APPLICATIONS

This application claims priority to and the benefit of Korean Patent Application No. 10-2009-0038432 filed in the Korean Intellectual Property Office on Apr. 30, 2009, the entire contents of which are incorporated herein by reference.

### BACKGROUND

1. Field

Aspects of the present invention relate to a plasma display device. More particularly, aspects of the present invention relate to a plasma display device that improves uniformity of luminance of a panel.

2. Description of the Related Art

As an example, a plasma display device includes an X-board assembly, a Y-board assembly, and an address buffer board assembly that control an X electrode, a Y electrode, and an A electrode, respectively, that drive a plasma display panel (PDP). The Y-board assembly that controls the Y electrode has a sustain circuit and a scan IC circuit on one substrate, and therefore when a sustain voltage waveform is applied, a current path is formed to be short. In this case, distortion of the sustain voltage waveform is reduced, thereby improving uniformity of panel luminance.

However, because the sustain circuit uses a large insulated gate bipolar transistor (IGBT) and a large field effect transistor (FET) operating with a large current and the scan IC circuit uses surface mount devices (SMD), when elements having different structures are disposed on one substrate, a process of manufacturing a printed circuit board assembly (PBA) becomes complicated.

The Y-board assembly is disposed in a vertical direction at a short side of the PDP to be connected thereto. Therefore, in a large PDP, there are large differences in the length of current paths for applying a sustain voltage waveform, i.e., current paths reaching Y electrodes from the Y-board assembly, according to position in a vertical direction of the PDP.

That is, in a vertical direction of the PDP, a current path is short around the center of the PDP and is lengthened toward both ends of the PDP. Therefore, toward both ends from the center in a vertical direction of the PDP, distortion of the Y-sustain voltage waveform increases and ringing and overshooting are aggravated.

A peak-to-peak voltage YVs (pk-pk) of the Y-sustain voltage waveform depends on a position in a vertical direction of the PDP (see FIG. 5A). Thereby, luminance (L) distribution in a vertical direction of the PDP is non-uniformly displayed.

The above information disclosed in this Background section is only for enhancement of understanding of the background of the invention and therefore it may contain information that does not form the prior art that is already known in this country to a person of ordinary skill in the art.

### SUMMARY

Aspects of the present invention have been made in an effort to provide a plasma display device having advantages of inexpensively improving uniformity of luminance in a vertical direction of a PDP.

Aspects of the present invention provide a plasma display device including: a plasma display panel (PDP) having an X electrode and a Y electrode that are disposed parallel to each other while intersecting an address electrode at a discharge cell; a Y-board assembly that controls the Y electrode of the PDP; a Y-buffer-board assembly including a scan integrated circuit (IC) connected to the Y-board assembly and that applies a scan voltage waveform and a sustain voltage waveform to the Y electrode; and a current supply element included in the Y-buffer-board assembly to supply a ground voltage to the Y-board assembly and to prevent overshooting of the sustain voltage waveform.

According to an aspect of the present invention, the Y-board assembly may include an isolation switch receiving the ground voltage from the current supply element.

According to an aspect of the present invention, the current supply element may include a diode having an anode terminal connected to a ground pattern of the Y-buffer-board assembly, and a field effect transistor (FET) having a drain terminal connected to a cathode terminal of the diode and a source terminal connected to an OUTL voltage.

According to an aspect of the present invention, the OUTL voltage outputs the sustain voltage waveform, and may be a voltage of a contact point to which a source terminal of the isolation switch is connected.

According to an aspect of the present invention, the current supply element may include a reverse blocking-insulated gate bipolar transistor (RB-IGBT) having a collector terminal connected to a ground pattern of the Y-buffer-board assembly and an emitter terminal connected to an OUTL voltage.

According to an aspect of the present invention, the current supply element may include a capacitor interposed between a ground pattern of the Y-buffer-board assembly and a power source line of the sustain voltage waveform.

According to an aspect of the present invention, the current supply element may include a diode including a cathode terminal connected to a side of the capacitor connected to the power source line and an anode terminal connected to an OUTL voltage.

According to an aspect of the present invention, the Y-buffer-board assembly may include a ground pattern, and the ground pattern may be grounded to a chassis base.

According to another aspect of the present invention, because a ground voltage is supplied to a Y-board assembly by mounting a current supply element in the Y-buffer-board assembly, a peak-to-peak voltage Vs(pk-pk) of a sustain voltage waveform of a Y electrode can be uniformly formed. Therefore, overshooting of the sustain voltage waveform of the Y electrode is prevented and thus luminance distribution in a vertical direction of the PDP is uniformly displayed.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram illustrating a plasma display device according to a first exemplary embodiment of the present invention.

FIG. 2 is a schematic diagram of a Y-board assembly and a Y-buffer-board assembly of FIG. 1.

FIG. 3 is a schematic diagram of a Y-board assembly and a Y-buffer-board assembly in a plasma display device according to a second exemplary embodiment of the present invention.

FIG. 4 is a schematic diagram of a Y-board assembly and a Y-buffer-board assembly in a plasma display device according to a third exemplary embodiment of the present invention.

FIGS. 5A and 5B are graphs illustrating a relationship between a peak-to-peak voltage and luminance of a Y-sustain voltage waveform in exemplary embodiments of the present invention and the conventional art.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

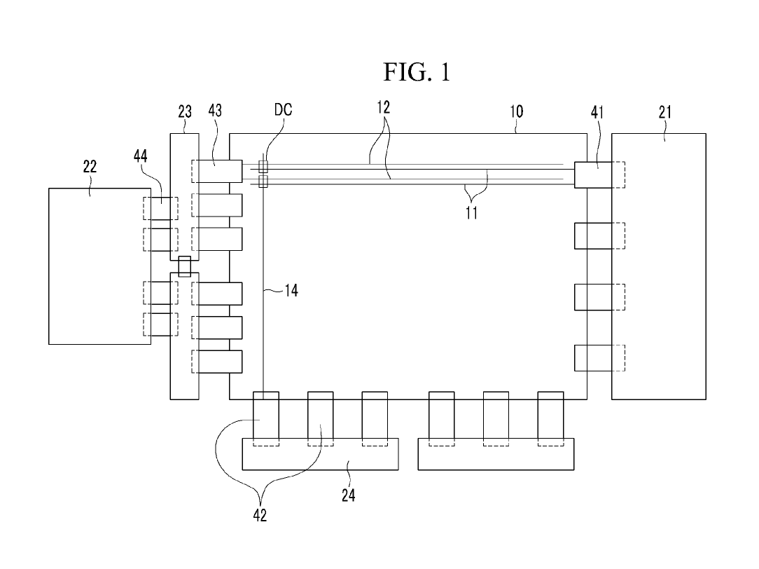

FIG. 1 is a schematic diagram illustrating a plasma display device according to a first exemplary embodiment of the present invention. Referring to FIG. 1, the plasma display device includes a PDP 10 that embodies an image, and printed circuit board assemblies (PBAs) that are formed to drive the PDP 10 and are electrically connected to the PDP 10.

The PDP 10 includes address electrodes 14 that are disposed to generate a plasma discharge in a discharge cell (DC), and X electrodes 11 and Y electrodes 12 that are disposed parallel to each other while intersecting the address electrodes 14. The DC has a well-known configuration, and thus a detailed description of the configuration thereof will be omitted.

The PBAs are formed as a multiple thereof to divide and perform functions that are related to driving of the PDP 10. For example, the PBAs include an X-board assembly 21 that controls the X electrodes 11, a Y-board assembly 22 and a Y-buffer-board assembly 23 that control the Y electrodes 12, and an address buffer board assembly 24 that controls the address electrodes 14.

In the X-board assembly 21, a flexible printed circuit (FPC) 41 is connected to the X-electrodes 11 of the PDP 10 to apply a sustain voltage waveform. In the address buffer board assembly 24, a tape carrier package (TCP) 42 is connected to the address electrodes 14 to apply an address voltage waveform.

In the Y-board assembly 22, an FPC 43 is connected to the Y electrodes 12 of the PDP 10 to apply a scan voltage waveform and a sustain voltage waveform. In this case, the Y-board assembly 22 is electrically connected to the Y-buffer-board assembly 23 through a connection member 44, and the FPC 43 connects the Y-buffer-board assembly 23 and the PDP 10.

Further, the PBAs control the X-board, the Y-board, the Y-buffer-board, and the address buffer board assemblies 21, 22, 23, and 24 and supply power thereto, and further include a control board assembly (not shown) and a power board assembly (not shown).

When the PDP 10 is driven, a reset discharge occurs according to a reset voltage waveform that is applied to the Y electrode 12 in a reset period. In a scan period following the reset period, an address discharge occurs by a scan voltage waveform that is applied to the Y electrode 12 and an address voltage waveform that is applied to the address electrode 14. Thereafter, in a sustain period, a sustain discharge occurs by a sustain voltage waveform that is applied to the X electrode 11 and the Y electrode 12.

The X electrode 11 and the Y electrode 12 are electrodes applying a sustain voltage waveform necessary for the sustain discharge. The Y electrode 12 performs a function of an electrode for applying a reset voltage waveform and a scan voltage waveform. The address electrode 14 applies an address voltage waveform. The X electrode 11, the Y electrode 12, and the address electrode 14 can perform different functions according to voltage waveforms that are applied thereto, and thus are not limited to the stated functions.

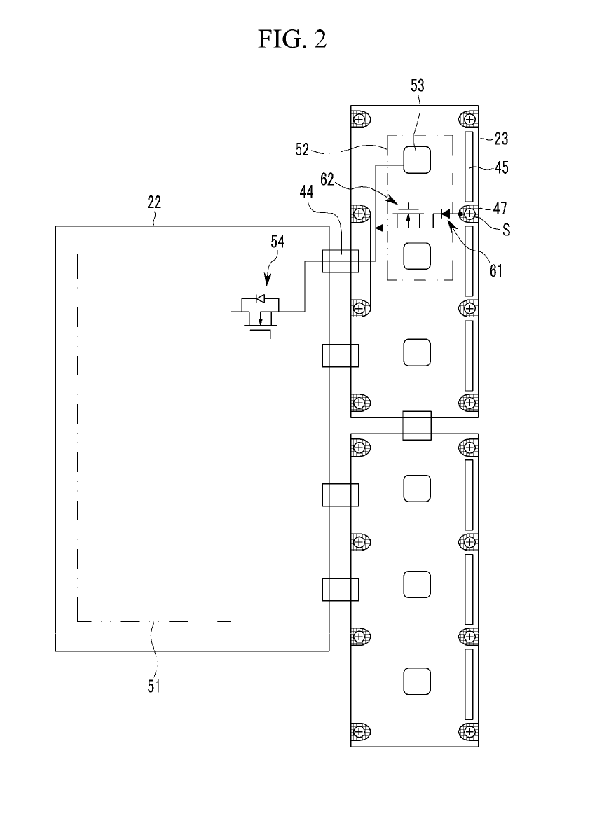

FIG. 2 is a schematic diagram of a Y-board assembly and a Y-buffer-board assembly of FIG. 1. Referring to FIG. 2, the Y-buffer-board assembly 23 includes a connector 45 that is connected to one end of the FPC 43 (see FIG. 1) that is connected to the PDP 10, and a connection member 44 that is connected to the Y-board assembly 22 and another Y-buffer-board assembly 23 that is mounted at a position adjacent thereto.

Further, the Y-buffer-board assembly 23 includes a ground pattern 47 around a mounting hole (not shown) that is formed in the Y-buffer-board assembly 23 and a mounting hole (not shown) for receiving a setscrew S. When the Y-buffer-board assembly 23 is mounted to the chassis base, the ground pattern 47 is electrically connected to the setscrew S and a boss (not shown) of the chassis base to be grounded.

In a configuration that controls the Y electrode 12, the Y-board assembly 22 forms a sustain circuit 51 that uses a large IGBT and a large FET operating with a large current. The Y-buffer-board assembly 23 includes a scan IC circuit 52 that uses a surface mounted device (SMD) such as a scan IC 53. The sustain circuit 51 and the scan IC circuit 52 use well-known technology and therefore a detailed description thereof will be omitted.

Further, the Y-board assembly 22 further includes an isolation switch 54 that connects the sustain circuit 51 and the scan IC circuit 52. The Y-buffer-board assembly 23 includes a current supply element for preventing overshooting of a sustain voltage waveform by supplying a ground voltage that is formed in the ground pattern 47 to the isolation switch 54.

The isolation switch 54 is turned on when an OUTL voltage is in a range from 0 volts to a sustain voltage (Vs) level. Therefore, the current supply element is formed to use a gate signal of the current supply element as a gate signal of the isolation switch 54.

In the first exemplary embodiment, the current supply element includes a diode 61 and a FET 62. In the diode 61, the anode terminal is connected to the ground pattern 47 of the Y-buffer-board assembly 23 to transfer a ground voltage to a cathode terminal. In the FET 62, the drain terminal is connected to the cathode terminal of the diode 61 and the source terminal is connected to the OUTL voltage. In order to use a gate signal of the isolation switch 54, the gate terminal of the FET 62 can be connected (not shown) to the gate terminal of the isolation switch 54.

The OUTL voltage outputs a sustain voltage waveform, and when outputting the sustain voltage waveform, the OUTL voltage changes within a range from a 0 volt level to the sustain voltage (Vs) level, or in other words a range from 0V-Vs. When the OUTL voltage of the Y-buffer-board assembly 23 is below 0V, the current supply element (that is, the diode 61 and the FET 62) supplies the ground voltage (0V) to the Y-board assembly. Therefore, the Y-sustain voltage waveform does not fall below 0V. Thereby, distortion of the Y-sustain voltage waveform is reduced, and uniformity of luminance in a vertical direction of the PDP 10 can be improved.

Hereinafter, various exemplary embodiments of the present invention are described, and constituent elements identical to or corresponding to those of the first exemplary embodiment will be omitted and only dissimilar constituent elements will be described in detail.

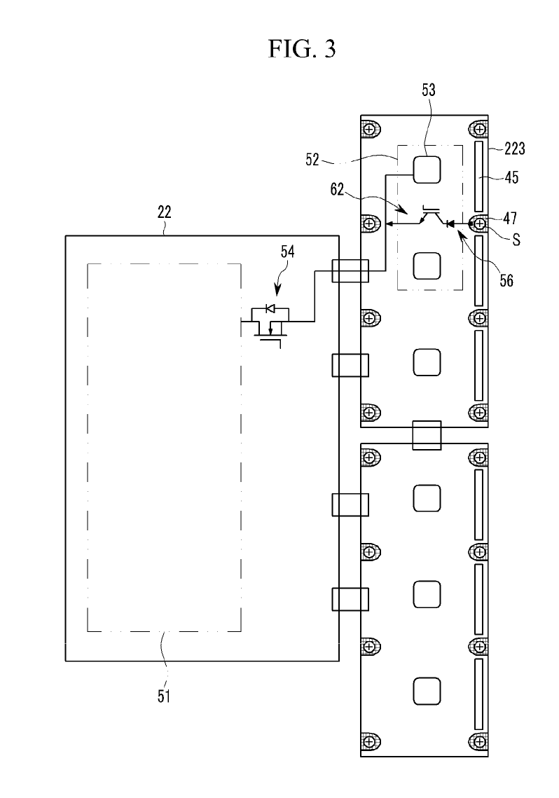

FIG. 3 is a schematic diagram of a Y-board assembly and a Y-buffer-board assembly in a plasma display device according to a second exemplary embodiment of the present invention. Referring to FIG. 3, in the first exemplary embodiment, the current supply element includes a diode 61 and a FET 62, and in the second exemplary embodiment, the current supply element includes a reverse blocking IGBT (RB-IGBT) (not shown).

In the RB-IGBT, the collector terminal is connected to a ground pattern 47 of a Y-buffer-board assembly 223, and the emitter terminal is connected to an OUTL voltage. In order to use a gate signal of the isolation switch 54, the gate terminal of the RB-IGBT can be connected (not shown) to a gate terminal of the isolation switch 54.

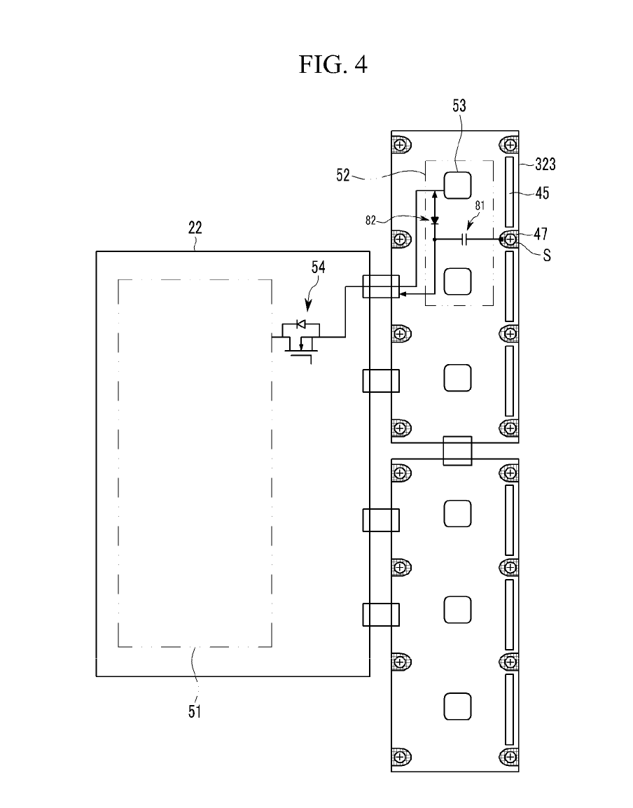

FIG. 4 is a schematic diagram of a Y-board assembly and a Y-buffer-board assembly in a plasma display device according to a third exemplary embodiment of the present invention. Referring to FIG. 4, the current supply element of the first and second exemplary embodiments prevents an OUTL voltage from falling below the ground voltage, and the current supply element of the third exemplary embodiment prevents an OUTL voltage from rising above a sustain voltage (Vs).

The current supply device of the third exemplary embodiment includes a capacitor 81 and a diode 82. The capacitor 81 is interposed between a ground pattern 47 of a Y-buffer-board assembly 323 and a power source line of a sustain voltage (Vs) pulse to suppress the sustain voltage (Vs) from changing in the power source line.

The cathode terminal of the diode 82 is connected to the capacitor 81 side that is connected to the power source line of the sustain voltage (Vs), and the anode terminal is connected to the OUTL voltage. When the OUTL voltage of the Y-buffer-board assembly 23 exceeds the sustain voltage (Vs), the current supply element (that is, the capacitor 81 and the diode 82) supplies the sustain voltage (Vs) to the Y-board assembly. Therefore, the Y-sustain voltage does not exceed the sustain voltage (Vs). In the third exemplary embodiment having the capacitor 81, a change of the sustain voltage (Vs) is suppressed, compared with the first and second exemplary embodiments, thereby more effectively reducing distortion of the Y-sustain voltage waveform.

The current supply device of the first to third exemplary embodiments can have other configurations, and can embody the above-described operation effect by combining two or more configurations.

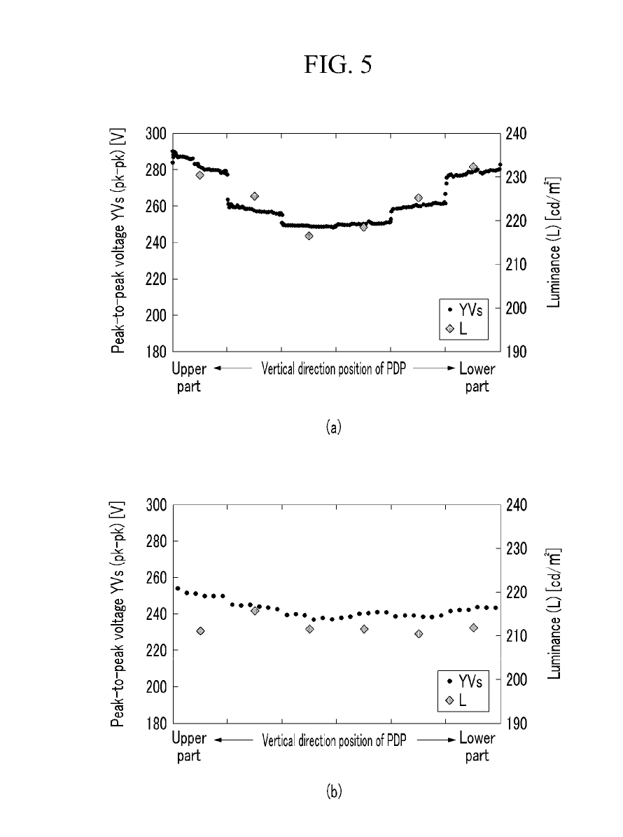

FIGS. 5A and 5B are graphs illustrating a relationship between a peak-to-peak voltage and luminance of a Y-sustain voltage waveform in the conventional art and in exemplary embodiments, respectively. FIG. 5A illustrates a measured result of a peak-to-peak voltage and luminance in a vertical direction of a PDP when having no current supply element that is described in the present exemplary embodiment, and FIG. 5B illustrates a measured result of a peak-to-peak voltage and luminance in a vertical direction of a PDP when having a current supply element that is described in the present exemplary embodiment.

Referring to FIG. 5A, peak-to-peak voltage YVs (pk-pk) of a Y-sustain voltage waveform largely depends on a position in the vertical direction of the PDP 10, and thus luminance (L) distribution in the vertical direction of the PDP 10 is non-uniform.

Referring to FIG. 5B, peak-to-peak voltage YVs (pk-pk) of a Y-sustain voltage waveform depends less on a position in the vertical direction of the PDP 10, and thus luminance (L) distribution in the vertical direction of the PDP 10 is more uniformly displayed.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display device comprising:
a plasma display panel (PDP) having an X electrode and a Y electrode that are disposed parallel to each other while intersecting an address electrode at a discharge cell;
a Y-board assembly that controls the Y electrode of the PDP;
a Y-buffer-board assembly including a scan integrated circuit (IC) connected to the Y-board assembly to apply a scan voltage waveform and a sustain voltage waveform to the Y electrode; and
a current supply element included in the Y-buffer-board assembly to supply a ground voltage to the Y-board assembly and to prevent overshooting of the sustain voltage waveform.

2. The plasma display device of claim 1, wherein the Y-board assembly includes an isolation switch receiving the ground voltage from the current supply element.

3. The plasma display device of claim 2, wherein the current supply element comprises:
a diode having an anode terminal connected to a ground pattern of the Y-buffer-board assembly; and
a field effect transistor (FET) having a drain terminal connected to a cathode terminal of the diode and a source terminal connected to an OUTL voltage.

4. The plasma display device of claim 3, wherein the OUTL voltage outputs the sustain voltage waveform, and is a voltage at a contact point to which a source terminal of the isolation switch is connected.

5. The plasma display device of claim 2, wherein the current supply element comprises a reverse blocking-insulated gate bipolar transistor (RB-IGBT) having a collector terminal connected to a ground pattern of the Y-buffer-board assembly and an emitter terminal connected to an OUTL voltage.

6. The plasma display device of claim 2, wherein the current supply element comprises a capacitor interposed between a ground pattern of the Y-buffer-board assembly and a power source line of the sustain voltage waveform.

7. The plasma display device of claim 6, wherein the current supply element comprises:
a diode including:
a cathode terminal connected to a side of the capacitor connected to the power source line; and
an anode terminal connected to an OUTL voltage.

8. The plasma display device of claim 2, wherein the Y-buffer-board assembly comprises a ground pattern, and the ground pattern is grounded to a chassis base.
